(19) United States
(12) Patent Application Publication
(10) Pub. No.: US 2025/0305924 A1
(43) Pub. Date: Oct. 2, 2025

(54) DEVICE FOR DIAGNOSING PARTICLES IN OPAQUE FLUID

(71) Applicant: INDUSTRY-ACADEMIC COOPERATION FOUNDATION GYEONGSANG NATIONAL UNIVERSITY, Jinju-si, Gyeongsangnam-do (KR)

(72) Inventor: Hyoung Bum KIM, Jinju-si, Gyeongsangnam-do (KR)

(73) Assignee: INDUSTRY-ACADEMIC COOPERATION FOUNDATION GYEONGSANG NATIONAL UNIVERSITY, Jinju-si, Gyeongsangnam-do (KR)

(21) Appl. No.: 18/864,012

(22) PCT Filed: May 11, 2023
(86) PCT No.: PCT/KR2023/006390

§ 371 Date: Dec. 4, 2024

(30) Foreign Application Priority Data
May 11, 2022 (KR) 10-2022-0057537

(51) Int. Cl. G01N 15/0227; G01N 15/00; G01N 15/14; G01N 15/1434

(52) U.S. Cl. CPC G01N 15/0227; G01N 15/1436; G01N 2015/0053; G01N 2015/1493

(57) ABSTRACT

The present invention provides a device for diagnosing particles in an opaque fluid including a flow cell for causing the opaque fluid mixed with the particles to flow, an illuminator composed of a plurality of light sources separated from each other such that infrared light is emitted to a fluid in the flow cell, a camera for photographing the opaque fluid in the flow cell, and an image processing unit for extracting sizes and shapes of the particles in the opaque fluid through an image captured by the camera, from the illuminator, the particles in the opaque fluid are photographed by the camera while an emission position of the infrared light is changed by adjusting emission positions of the plurality of light sources.

### TECHNICAL FIELD

The present invention relates to a device for diagnosing particles in an opaque fluid which diagnoses the presence or absence of unpulverized or combined particles in an opaque fluid and sizes and shapes of the particles based on a captured image.

### BACKGROUND ART

Generally, diagnosing the presence or absence of large particles that are not pulverized or combined with each other in the process of pulverizing and mixing several components by a mixer to a certain size or less is important in various technical fields, such as chemistry, biology, pharmacy, and environmental monitoring.

In particular, carbon, graphite, and other metal components are mixed in the negative or positive electrode materials of a secondary battery, and when there are large particles that are not well mixed, a low-quality battery is produced, and accordingly, diagnosing the presence or absence of particles larger than a certain size is important, but diagnosing the presence or absence of particles in an opaque fluid is not easy.

There are several methods for diagnosing the presence or absence of particles or single particle in a fluid, and among the several methods, an optical measurement method or a labeling method is mainly used.

However, a method of diagnosing particles by using a labeling method has a problem that measurement is impossible in the case of a fast process because the label itself may change the properties of target particles, and the low emissivity inherent in the fluorophore limits a measurement rate. In addition, there is a problem that it is difficult and cumbersome to attach a label to the particles to be diagnosed.

In addition, in the case of conventional optical measurement, the presence or absence of particles and the diagnosis are mainly performed by using ultrasound, and the particles in the fluid are photographed, and in this case, in order to enable the particles to be photographed, a separate dilution solution has to be introduced offline such that the fluid has a certain transparency or higher, and accordingly, there is a problem that the diagnosis of particles in an opaque fluid is cumbersome.

Related technology for the presence or absence of particles in the fluid and the diagnosis of particles is disclosed in Korea Patent Publication No. 10-2021-0153601 (2021. 12.17).

### DISCLOSURE

### Technical Problem

An object of the present invention is to provide a device that diagnoses particles in an opaque fluid and accurately diagnoses the presence or absence of particles larger than a certain size in the opaque fluid and sized and shapes of the particles based on an image acquired by a camera.

### Technical Solution

The present invention provides a device for diagnosing particles in an opaque fluid including a flow cell for causing the opaque fluid mixed with the particles to flow, an illuminator composed of a plurality of light sources separated from each other such that infrared light is emitted to a fluid in the flow cell, a camera for photographing the opaque fluid in the flow cell, and an image processing unit for extracting sizes and shapes of the particles in the opaque fluid through an image captured by the camera, from the illuminator, the particles in the opaque fluid are photographed by the camera while an emission position of the infrared light is changed by adjusting emission positions of the plurality of light sources.

Also, the plurality of light sources may sequentially and continuously emit light in a predetermined pattern.

Also, some of the plurality of light sources may randomly and continuously emit light.

Also, the plurality of light sources may sequentially and continuously emit light in a clockwise or counterclockwise direction.

Also, the plurality of light sources may be arranged to be separated from each other in a direction where the fluid moves and a direction perpendicular to the direction where the fluid moves, based on a photographing point of the camera.

Also, the plurality of light sources may be arranged to be separated from each other at a predetermined interval in a ring shape.

### Advantageous Effects

In a device for diagnosing particles in an opaque fluid, according to an embodiment, an illuminator emits infrared light when a camera photographs an opaque fluid flowing in a flow cell, and in this case, the camera photographs the opaque fluid while changing an emission position of the infrared light to a photographing position of the camera by adjusting the light emission position of a plurality of light sources, and thus, the device for diagnosing particles may accurately obtain sizes and shapes of particles in an opaque fluid while reducing occurrence of speckle of the particles in the opaque fluid and increasing a depth of the captured image.

### DESCRIPTION OF DRAWINGS

FIG. 1 is a configuration diagram illustrating a device for diagnosing particles in an opaque fluid, according to an embodiment of the present invention.

FIG. 2 is an enlarged configuration diagram of a portion ‘A’ illustrated in FIG. 1.

FIG. 3 is a plan view of an illuminator illustrated in FIG. 2.

FIG. 4 is a side view of an illuminator illustrated in FIG. 2.

FIG. 5 is an image obtained by photographing a fluid by using a device for diagnosing particles in an opaque fluid, according to an embodiment of the present invention.

### MODE FOR INVENTION

Hereinafter, a preferred embodiment according to the present invention will be described in detail with reference to the attached drawings. Prior to this, terms or words used in the present specification and claims should not be interpreted as limited to their usual or dictionary meanings and should be interpreted as meanings and concepts that conform to the technical idea of the present invention based on the principle that the inventor may appropriately define the concepts of the terms in order to describe his or her own invention in the best way.

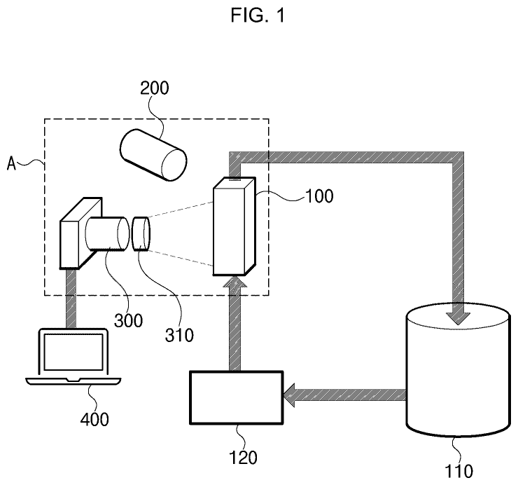

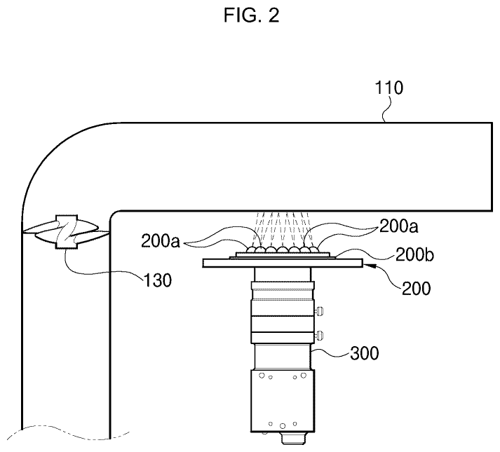

Referring to FIGS. 1 and 2, a device for diagnosing particles in an opaque fluid, according to an embodiment of the present invention includes a flow cell 100, an illuminator 200, a camera 300, and an image processing unit 400.

The flow cell 100 is a portion that causes an opaque fluid including diagnose target particles to flow. This flow cell 100 is formed in a conduit shape to guide the fluid to move while containing the fluid therein. In this case, the flow cell 100 may be connected to a fluid tank 110 that stores an opaque fluid mixed with particles, and a fluid pump 120 that pumps the fluid in the fluid tank 110 to circulate and move through the flow cell 100. In this case, an exchanger (not illustrated) is provided inside the fluid tank 110 to cause the fluid and particles to be mixed to prevent sedimentation of particles in the fluid.

In addition, an impeller 130 that causes the fluid to move through the flow cell 100 and the particles mixed in the fluid to be inertially separated may be connected to one side of the inside of the flow cell 100. More specifically, the impeller 130 is provided inside the flow cell 100 in front of a position of the flow cell 100 photographed by the camera 300 described below to cause particles to be separated from a fluid at a point of the flow cell 100 photographed by the camera 300 and to cause particles with large mass to be gathered, and accordingly, images of particles may be stably acquired by the light source 200 and the camera 300.

The illuminator 200 is a portion that emits infrared light to enable detection of particles in the fluid when photographing the fluid in the flow cell 100 by the camera 300. In this case, the illuminator 200 emits short-wave infrared light such that occurrence speckle of particles in the fluid may be minimized and a measurement depth of the captured image may be increased when photographing the fluid by using the camera 300. That is, the shorter the wavelength of the infrared light, the higher the stray light portion of the particle surface, and accordingly, a particle surface shape captured by the camera 300 is clearly viewed, and the longer the wavelength of the infrared light, the more the infrared light is transmitted, causing the particle surface shape captured by the camera 300 to be not clearly viewed. In this case, the infrared light may have a wavelength of 780 nm or more.

In addition, it is preferable that the illuminator 200 is provided in pairs to be arranged on both sides of the camera 300 based on the camera 300 but is not limited thereto, and a plurality of illuminators may be provided to be separated from each other at a certain interval around the camera 300.

In addition, the illuminator 200 may be composed of a plurality of light sources 200a separated from each other such that, when photographing the fluid by using the camera 300, the illuminator 200 emits multiple beams of infrared light from different positions as points photographed by the camera 300. In this way, when the illuminator 200 is composed of a plurality of light sources 200a separated from each other, the occurrence of speckle in particles in a fluid is minimized, and a depth of an image captured by the camera 300 is increased, and accordingly, sizes and shapes of images of particles in the fluid may be accurately acquired. In addition, when infrared light is emitted from the illuminator 200a of the illuminator 200, a fluid may be photographed by the camera while changing an emission position of the infrared light through adjustment of the light emission position for the plurality of light sources 200a such that a speckle occurrence rate is further reduced, a depth of the captured image is further increased, and sizes and shapes of images of particles in the fluid may be more accurately acquired. Here, a reference number 200b is a lighting body that fixes the plurality of light sources 200a in a mounted state.

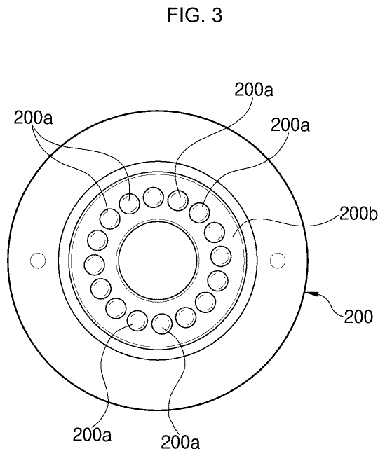

Referring to FIG. 3, the plurality of light sources 200a may be arranged to be separated from each other in a direction of movement of an opaque fluid in the flow cell 100 and in a direction perpendicular to the direction of movement of the opaque fluid. In more detail, the plurality of light sources 200a are illustrated as being separated from each other at regular intervals in a ring shape but are not limited thereto and may be separated from each other at regular intervals in a grid shape.

In this way, in a state where the plurality of light sources 200a are separated from each other at regular intervals in a ring shape, the plurality of light sources 200a may sequentially and continuously emit light in a certain pattern, and in this case, the plurality of light sources 200a may sequentially and continuously emit light in a clockwise or counterclockwise direction.

In addition, in another embodiment, some of the plurality of light sources 200a may randomly and continuously emit light.

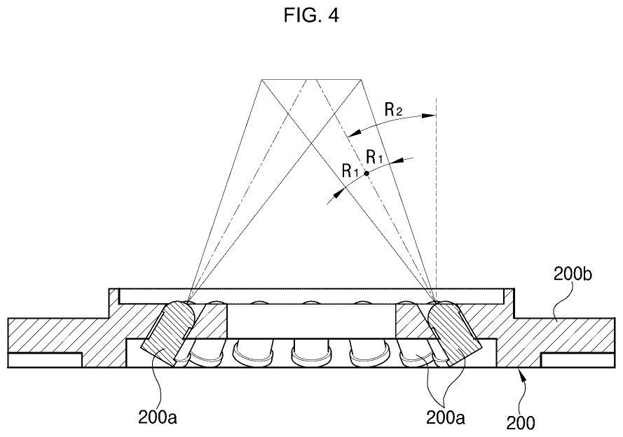

Also, referring to FIG. 4, the plurality of light sources 200a applied to the illuminator 200 are coaxial light sources to ensure clear imaging and uniform brightness. In addition, a half-radiation intensity angle ‘R1’ of the light source 200a is 10 degrees, and an installation angle ‘R2’ of the light source 200a is preferably set to 70 degrees such that all emission beam of the light source 200a converges on a focal plane of the camera 300.

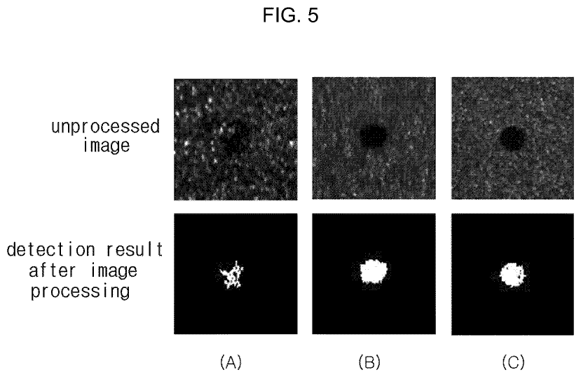

Referring to FIG. 5, extraction results (C) of sizes and shapes of particles extracted by the image processing unit 400 when the camera 300 photographs a fluid while the plurality of light sources 200a sequentially and continuously emit light in a clockwise or counterclockwise direction in a state where the plurality of light sources 200a of the illuminator 200 are arranged to be separated from each other at regular intervals in a ring shape, extraction results (B) of sizes and shapes of particles extracted by the image processing unit 400 when the camera 300 photographs a fluid while some of the plurality of light sources 200a are randomly and continuously emit light, and extraction results (A) of sizes and shapes of particles extracted by the image processing unit 400 when the camera 300 photographs a fluid simply by causing the light source to emit light from a fixed and constant position, are compared with each other, and as a result, clear images of regular and irregular particles in an opaque fluid are obtained in a case where the plurality of light sources 200a sequentially and continuously emit light in a certain pattern and in a case where some of the plurality of light sources 200a are randomly and continuously emit light, and accordingly sizes and shapes of particles in an opaque fluid may be accurately extracted by the image processing unit 400.

The camera 300 photographs a fluid moving inside the flow cell 100. The camera 300 generates an image for analyzing particles included in the fluid inside the flow cell 100. In this case, the camera 300 is installed to be placed in the center of the illuminator 200, and more specifically, when multiple illuminators 200 are placed, the camera 300 may be installed to be placed in the center of the multiple illuminators 200. It goes without saying that the camera 300 may be equipped with an optical filter 310.

The image processing unit 400 extracts sizes and shapes of particles in a fluid through the images captured by the camera 300. The image processing unit 400 is connected to the camera 300 through wired means such as a cable or wireless means such as Bluetooth, Wi-Fi, or infrared communication, and receives images captured by the camera 300.

In this case, the image processing unit 400 stores a program that may extract sizes and shapes of particles in a fluid through the images received from the camera 300, and more specifically, the image processing unit 400 extracts the sizes and shapes of the particles in the fluid by using a program that applies an image processing technique. In this way, the sizes and shapes of particles in a fluid extracted by the image processing unit 400 may also be output through a display (not illustrated in the drawing) such as a monitor.

In this way, in a device for diagnosing particles in an opaque fluid, according to an embodiment, the illuminator 200 emits infrared light when the camera 300 photographs an opaque fluid flowing in the flow cell 100, and in this case, the camera photographs the opaque fluid while changing an emission position of the infrared light to a photographing position of the camera 300 by adjusting the light emission position of the plurality of light sources 200a, and thus, the device for diagnosing particles may accurately obtain sizes and shapes of particles in an opaque fluid while reducing occurrence of speckle of the particles in the opaque fluid and increasing a depth of the captured image.

The present invention is described with reference to the embodiments illustrated in the drawings, but the embodiments are merely examples, and those skilled in the art will understand that various modifications and equivalent other embodiments are possible the embodiments. Therefore, the true technical protection scope of the present invention should be determined by the technical idea of the appended claims.

1. A device for diagnosing particles in an opaque fluid, the device comprising:
a flow cell for causing the opaque fluid mixed with the particles to flow;
an illuminator composed of a plurality of light sources separated from each other such that infrared light is emitted to a fluid in the flow cell;
a camera for photographing the opaque fluid in the flow cell; and
an image processing unit for extracting sizes and shapes of the particles in the opaque fluid through an image captured by the camera,
wherein, when the infrared light is emitted from the illuminator, the particles in the opaque fluid are photographed by the camera while an emission position of the infrared light is changed by adjusting emission positions of the plurality of light sources.

2. The device for diagnosing the particles in the opaque fluid of claim 1, wherein the plurality of light sources sequentially and continuously emit light in a predetermined pattern.

3. The device for diagnosing the particles in the opaque fluid of claim 1, wherein some of the plurality of light sources randomly and continuously emit light.

4. The device for diagnosing the particles in the opaque fluid of claim 2, wherein the plurality of light sources sequentially and continuously emit light in a clockwise or counterclockwise direction.

5. The device for diagnosing the particles in the opaque fluid of claim 1, wherein the plurality of light sources are arranged to be separated from each other in a direction where the fluid moves and a direction perpendicular to the direction where the fluid moves, based on a photographing point of the camera.

6. The device for diagnosing the particles in the opaque fluid of claim 1, wherein the plurality of light sources are arranged to be separated from each other at a predetermined interval in a ring shape.
